(19) United States
(12) Patent Application Publication
(10) Pub. No.: US 2026/0070814 A1
(43) Pub. Date: Mar. 12, 2026

(54) METHOD AND APPARATUS FOR SELECTIVELY FEEDING BRINE STREAM

(71) Applicant: ACWA POWER Company, Riyadh (SA)

(72) Inventors: Justin Robert Paden Justin PALACE, Dubai (AE); Ahmed Yousry Ahmed MAHMOUD, Dubai (AE); Hassan Abdulaziz ALMSAEED, Dubai (AE); Tariq Nabil NADA, Jeddah (SA)

(73) Assignee: ACWA POWER Company, Riyadh (SA)

(21) Appl. No.: 18/828,139

(22) Filed: Sep. 9, 2024

(51) Int. Cl. C02F 1/26; C02F 103/08

(52) U.S. Cl. CPC C02F 1/265; C02F 2103/08; C02F 2209/03; C02F 2209/40

(57) ABSTRACT

A method, controller and apparatus for selectively feeding a brine stream includes controlling an inlet to receive a liquid stream, and controlling a first pressure pump to output a first boosted liquid stream using the received liquid stream. They also include controlling a treatment unit to output at least a brine stream by passing the liquid stream through it, and determining pressure data associated with the first boosted liquid stream at the second port. The first pressure pump includes first and second ports, the first port receives the liquid stream, and the second port outputs the first boosted liquid stream. The method, controller and apparatus also include controlling either a first or second valve, selectively to feed the brine stream to either the first or second port, respectively, based upon the pressure data.

### TECHNICAL FIELD

The present disclosure generally relates to water treatment and more particularly relates to an apparatus and a method for selectively feeding brine stream.

### BACKGROUND

In recent years, the problem of water shortage has increased on a global level. Owing to a shortage of freshwater, seawater may be filtered to make it fit for human consumption. Desalination, a process of removing salts and other impurities from seawater to produce fresh or potable water, has emerged as a vital solution to address the challenge of water shortage. Conventional desalination techniques primarily include thermal distillation and membrane-based processes, such as reverse osmosis (RO).

RO has become the predominant desalination technology due to its higher energy efficiency compared to thermal methods. However, RO-based desalination systems still face several challenges. One such challenge is high energy consumption. As a result, RO-based desalination systems are costly and often rely on non-renewable energy sources to meet energy demands.

Therefore, there is a need to overcome the challenges associated with the RO desalination systems having high energy consumption.

### SUMMARY

In comparison with the traditional techniques the present disclosure provides a seawater RO desalination apparatus for the seawater reverse osmosis process to produce freshwater that allows reduced energy utilization thereby reducing the cost of the desalination process.

It is an objective of the disclosure to provide an improved seawater RO desalination apparatus to produce freshwater or potable water. The improved seawater RO desalination apparatus enables to achieve reduced specific energy consumption (SEC) in a seawater RO desalination. The apparatus may reduce the power consumption for the seawater RO desalination and may enhance energy efficiency.

In one aspect, a method for selectively feeding brine stream is provided. The method includes controlling an inlet to receive a liquid stream, controlling a first pressure pump to output a first boosted liquid stream using the received liquid stream, and controlling a treatment unit to output at least a brine stream by passing the liquid stream therethrough. The first pressure pump includes a first port and a second port. The first port receives the liquid stream, and the second port outputs the first boosted liquid stream. The method further includes determining pressure data associated with the first boosted liquid stream at the second port, and controlling one of: a first valve or a second valve to selectively feed the brine stream to one of: the first port or the second port, respectively, based on the pressure data.

In an embodiment, the pressure data comprises a first pressure value associated with the first boosted liquid stream at the second port. The method further includes determining, using the one or more pressure sensors, a second pressure value associated with the brine stream. The method further includes comparing the first pressure value with the second pressure value and controlling the second valve to feed the brine stream to the second port in response to determining the first pressure value to be less than the second pressure value.

In an embodiment, the method further includes controlling the first valve to feed the brine stream to the first port in response to determining the first pressure value to be greater than the second pressure value.

In an embodiment, the first pressure pump comprises a low-pressure pump (LPP). The first pressure pump is configured to boost a first pressure level of the liquid stream to a second pressure level of the first boosted liquid stream, such that the second pressure level is higher than the first pressure level.

In an embodiment, the method further includes controlling a second pressure pump to output a second boosted liquid stream using the first boosted liquid stream. The second pressure pump is in fluid communication with the first pressure pump.

In an embodiment, the second pressure pump comprises a high-pressure pump (HPP). The second pressure pump is configured to boost a second pressure level of the first boosted liquid stream to a third pressure level of the second boosted liquid stream, such that the third pressure level is higher than the second pressure level.

In an embodiment, the treatment unit comprises a first set of reverse osmosis (RO) membranes and a second set of RO membranes, the first set of RO membranes is fed with the second boosted liquid stream to output at least a first permeate stream and a first pass brine stream. Further, the second set of RO membranes is fed with the first permeate stream to output at least a second permeate stream and a second pass brine stream.

In an embodiment, one of: the first valve or the second valve is controlled to selectively feed the second pass brine stream to one of: the first port or the second port, respectively, based on the pressure data.

In an embodiment, the liquid stream is one of: pre-treated seawater, or a mixture of the of pre-treated seawater and the brine stream.

In another embodiment, a controller for selectively feeding brine stream is provided. The controller includes one or more processors configured to control an inlet to receive a liquid stream and control a first pressure pump to output a first boosted liquid stream using the received liquid stream. The first pressure pump includes a first port and a second port. The first port receives the liquid stream, and the second port outputs the first boosted liquid stream. The one or more processors are further configured to control a treatment unit to output at least a brine stream by passing the liquid stream therethrough. The one or more processors are further configured to determine pressure data associated with the first boosted liquid stream at the second port. The one or more processors are further configured to control one of: a first valve or a second valve to selectively feed the brine stream to one of: the first port or the second port, respectively, based on the pressure data.

In an embodiment, the pressure data comprises a first pressure value associated with the first boosted liquid stream at the second port. Further, the one or more processors are configured to determine using the one or more pressure sensors, a second pressure value associated with the brine stream. Further, the one or more processors are configured to compare the first pressure value with the second pressure value and control the second valve to feed the brine stream to the second port in response to determining the first pressure value to be less than the second pressure value.

In an embodiment, the one or more processors are further configured to control the first valve to feed the brine stream to the first port in response to determining the first pressure value to be greater than the second pressure value.

In an embodiment, the first pressure pump comprises a low-pressure pump (LPP), and the first pressure pump is configured to boost a first pressure level of the liquid stream to a second pressure level of the first boosted liquid stream, such that the second pressure level is higher than the first pressure level.

In an embodiment, the one or more processors are further configured to control a second pressure pump to output a second boosted liquid stream using the first boosted liquid stream. The second pressure pump is in fluid communication with the first pressure pump.

In an embodiment, the second pressure pump comprises a high-pressure pump (HPP), and the second pressure pump is configured to boost a second pressure level of the first boosted liquid stream to a third pressure level of the second boosted liquid stream, such that the third pressure level is higher than the second pressure level.

In an embodiment, the treatment unit comprises a first set of reverse osmosis (RO) membranes and a second set of RO membranes, and the first set of RO membranes is fed with the second boosted liquid stream to output at least a first permeate stream and a first pass brine stream. Moreover, the second set of RO membranes is fed with the first permeate stream to output at least a second permeate stream and a second pass brine stream.

In additional controller embodiment, one of: the first valve or the second valve is controlled to selectively feed the second pass brine stream to one of: the first port or the second port, respectively, based on the pressure data.

In yet another aspect, an apparatus for selectively feeding brine stream is provided, the apparatus includes an inlet to receive a liquid stream, a first pressure pump to output a first boosted liquid stream using the received liquid stream, a treatment unit to output at least a brine stream by passing the liquid stream therethrough, a first valve connected to the first port to control a water flow thereto, and a second valve connected to the second port to control a water flow thereto. The first pressure pump includes a first port and a second port. The first port receives the liquid stream and the second port outputs the first boosted liquid stream. The apparatus further includes one or more pressure sensors arranged to measure pressure data associated with the first boosted liquid stream at the second port, and a controller. The controller is configured to receive the pressure data associated with the first boosted liquid stream at the second port. The pressure data comprises a first pressure value. The controller is further configured to determine using the one or more pressure sensors, a second pressure value associated with the brine stream. The controller is further configured to compare the first pressure value with the second pressure value and control one of: the first valve or the second valve to selectively feed the brine stream to one of: the first port or the second port, respectively, based on the comparison.

In an embodiment, the first pressure pump comprises a low-pressure pump (LPP), and wherein the first pressure pump is configured to boost a first pressure level of the liquid stream to a second pressure level of the first boosted liquid stream, such that the second pressure level is higher than the first pressure level.

In an embodiment, the apparatus further includes a second pressure pump to output a second boosted liquid stream using the first boosted liquid stream. The second pressure pump is in fluid communication with the first pressure pump.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a network environment in which an apparatus for selectively feeding brine stream is implemented, in accordance with an embodiment of the disclosure;

FIG. 2 illustrates a block diagram of a controller of the apparatus for controlling selective feeding of the brine stream, in accordance with an embodiment of the disclosure;

FIG. 3A illustrates a schematic flow diagram of exemplary operations for brine recirculation mechanism, in accordance with an embodiment of the disclosure;

FIG. 3B illustrates a block diagram of a treatment unit of the apparatus for brine recirculation mechanism, in accordance with an embodiment of the disclosure;

FIG. 4 illustrates a block diagram of exemplary operations of the apparatus for selectively feeding the brine stream, in accordance with an embodiment of the disclosure;

FIG. 5 illustrates a flowchart of a method for controlling a flow of a second pass brine stream, in accordance with an embodiment of the disclosure; and

FIG. 6 illustrates a flowchart of a method for selectively feeding the brine stream, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

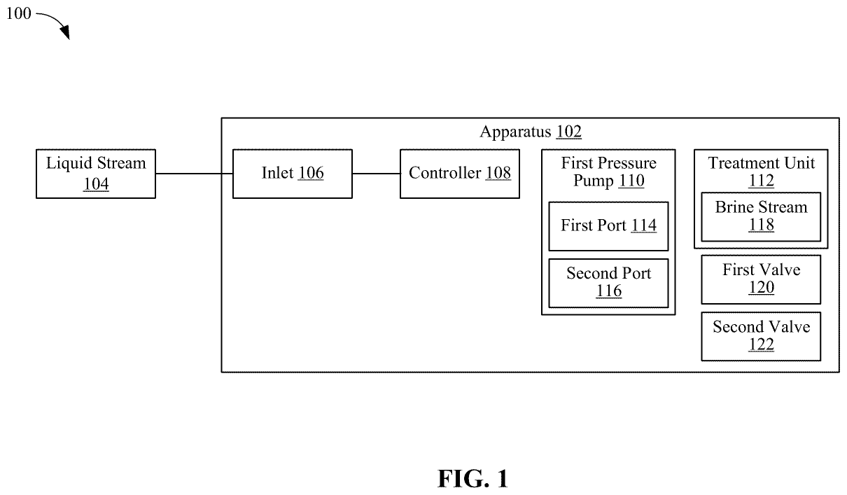

FIG. 1 illustrates an environment 100 in which an apparatus 102 for selectively feeding brine stream is implemented, in accordance with an embodiment of the disclosure. In an example, the apparatus 102 may be implemented with or may include a seawater RO system (referred to as a treatment unit) to produce freshwater. The environment 100 may include the apparatus 102 which may be used for selectively feeding brine stream. The environment 100 may further include a liquid stream 104 and an inlet 106. The apparatus 102 may include a controller 108, a first pressure pump 110, a treatment unit 112, a first valve 120, and a second valve 122. The first pressure pump 110 may include a first port 114 and a second port 116. The treatment unit 112 may be operable to output a brine stream 118. Further, the controller 108 is configured to control a flow of the brine stream 118.

The apparatus 102 or the controller 108 may be configured to control the inlet 106 to receive the liquid stream 104 as input. For example, the liquid stream 104 may be, but is not limited to, seawater. The inlet 106 may receive the liquid stream 104 from various sources. The apparatus 102, specifically, the treatment unit 112 may employ RO membranes for filtering the liquid stream 104 to remove impurities, salt, and other dissolved minerals. The apparatus 102 or the treatment unit 112 of the apparatus 102 may filter the liquid stream 104 to produce the filtered liquid stream, i.e., permeate stream. The filtered liquid stream may be freshwater fit for consumption.

In one embodiment, the apparatus 102 may be, but is not limited to, an industrial RO plant, a domestic RO plant, a seawater desalination plant, a portable RO plant, or a wastewater reclamation RO plant.

In an embodiment, the first pressure pump 110 is operable to output a first boosted liquid stream using the liquid stream 104. In an example, the first pressure pump 110 may increase a pressure of a liquid stream 104 to boost a pressure level of the liquid stream. To this end, by boosting the pressure level of the liquid stream 104, the first pressure pump 110 may output the first boosted liquid stream. For example, the first pressure pump 110 may include one or more impellers. The one or more impellers may be utilized to convert kinetic energy to pressure energy and to boost the pressure of the liquid stream 104.

Moreover, the first pressure pump 110 includes the first port 114 and the second port 116. The second port 116 outputs the first boosted liquid stream. In an example, the first port 114 serves as an inlet for the first pressure pump 110, where the liquid stream 104 is introduced. The first port 114 is engineered to minimize turbulence and ensure a smooth entry of the liquid stream 104 into the first pressure pump 110. The design of the first port 114 is crucial, as it directly impacts the first pressure pump 110 efficiency and performance.

The second port 116 functions as an outlet for the first pressure pump 110, where the first boosted liquid stream is discharged. The second port 116 is designed to facilitate a smooth transition of the pressurized first boosted liquid stream into the next stage of the apparatus 102. For example, the pressurized first boosted liquid stream may be fed to the treatment unit 112 in the next stage. The first pressure pump 110 utilizes its internal components, such as the impellers and diffusers, to increase the pressure of the liquid stream 104. As the liquid stream 104 enters the first pressure pump 110 through the first port 110, the first pressure pump 110 increases the pressure of the liquid stream 104 by accelerating rotation, such as a rotation speed of the impeller, converting the kinetic energy into pressure energy. The diffuser then helps to convert the high-velocity flow into a high-pressure flow, which is then discharged through the second port 116 as the first boosted liquid stream. The first pressure pump 110 may be capable of handling a required flow rate and pressure requirements while maintaining high efficiency and reliability. By incorporating the first pressure pump 110, the apparatus 102 may effectively boost the pressure of the incoming liquid stream 104, enabling it to be transported or used in applications that require higher pressure levels.

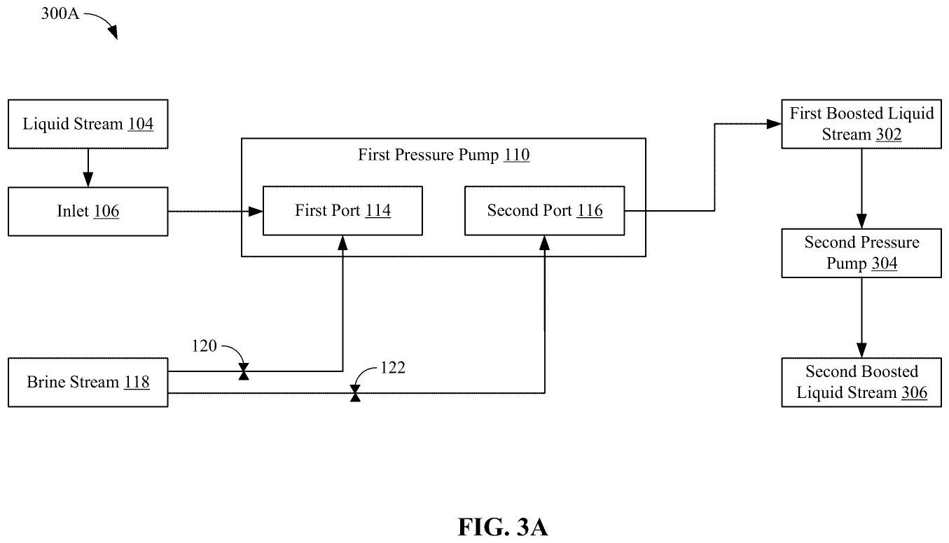

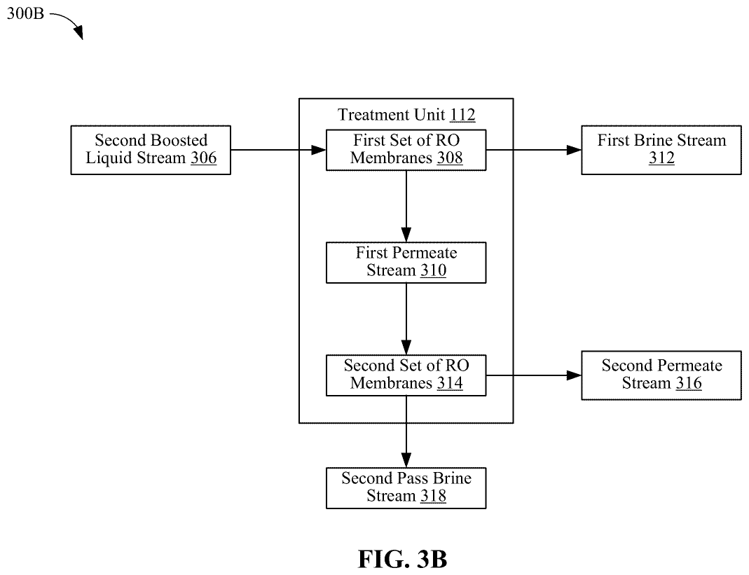

The apparatus 102 further comprises the treatment unit 112 to output at least the brine stream 118 by passing the liquid stream 104 therethrough. In an example, the treatment unit 112 is designed to process the incoming liquid stream 104, i.e., boosted liquid stream. The treatment unit 112 operates by passing the liquid stream through various processes including, but not limited to, filtration, separation, or chemical treatment processes, effectively removing impurities and unwanted components from the liquid stream 104, particularly boosted liquid stream. For example, the treatment unit 112 may output a permeate stream, i.e., fresh or filtered water, and a brine stream, i.e., a concentrated solution of salts and other dissolved solids. This brine stream 118 may be generated through processes such as, but not limited to, reverse osmosis or evaporation, where the liquid stream 104 undergoes treatment to separate water from dissolved salts. The treatment unit 112 may use a set of reverse osmosis (RO) membranes to separate particles and unwanted dissolved solids from the liquid stream 104. The treatment unit 112 may operate on the principle of sieving, allowing water and small molecules to pass through while retaining larger particles. The treatment unit 112 may include one or more RO membranes, for example, having different porosity. Further details about the treatment unit 112 are provided in conjunction with, for example, FIG. 3B.

The apparatus 102 may further include the first valve 120 connected to the first port 114 to control a water flow to the first port 114. The apparatus 102 may further include the second valve 122 connected to the second port 116 to control a water flow to the second port 116. In an example, the controller 108 may be configured to regulate the flow of the brine stream 118 that is produced by the treatment plant 112 to the first port 114 or the second port 116 by controlling the first valve 120 or the second value 122, respectively.

In an example, the brine stream 118, which is a concentrated solution of salts and impurities, produced in a previous batch of filtration may be mixed with the incoming liquid stream 104 received from the inlet 106 in a current batch at the first port 114. In another example, the brine stream 118 produced in the previous batch of filtration may be mixed with the first boosted liquid stream 104 boosted by the first pressure pump 110 in a current batch at the second port 116.

Once the brine stream 118 is adequately mixed with the liquid stream 104 The combined mixture is directed to the first port 114 of the first pressure pump 110. In another embodiment, the brine stream 118 is mixed with the first boosted liquid stream at the second port 116. The mixing of the brine stream 118 and the liquid stream 104 allows for enhanced processing and treatment of the liquid stream 104, ensuring that the apparatus 102 operates efficiently. By controlling the water flow of the brine stream 118 to the first port 114 or the second port 116, the apparatus 102 may optimize performance, maintain desired pressure levels, and ensure energy efficiency during the treatment of the incoming liquid stream 104.

In an example, the controller 108 may be configured to control the flow of the brine stream 118 to the first port 114 or the second port 116 based on a first pressure value at the second port 116. In an example, the fist valve 120 may control the flow of the brine stream 118 as it exits the treatment unit 112 into the first port 114, while the second valve 122 may control the flow of the brine stream 118 as it exits the treatment unit 112 into the second port 116. By precisely regulating this flow, the first valve 120 and the second valve 122 helps to maintain an optimal pressure in the input or feed water of the treatment unit to ensure efficient operation of the treatment unit. Further, by boosting the pressure of the liquid stream 104 or first boosted liquid stream using the brine stream 118, power savings or energy conservation may be achieved. This power saving may be a result of lesser flow required for passing the liquid stream 104 through the first pressure pump 110 and/or passing the first boosted liquid stream through other second pressure pump(s) associated with the apparatus 102. Specifically, pressure boosting may be achieved by adding high pressure brine stream 118 to the liquid stream 104 or the first boosted liquid stream. As a result, operation of the first pressure pump 110 and/or other second pressure pump(s) may be required for lesser time or for lesser flow.

The controller 108 is programmed to manage the flow of the brine stream 118 by controlling the first valve 120 or the second valve 122 based on the first pressure value measured at the second port 116.

The apparatus 102 may include one or more pressure sensors arranged to measure pressure data associated with the first boosted liquid stream at the second port 116 and the liquid stream 104 at the first port 114. In an example, the one or more pressure sensors play a crucial role in monitoring and optimizing the performance of the first pressure pump 110 and/or other pressure pumps in the apparatus 102. By measuring the pressure at the second port 116, where the boosted liquid stream is discharged, the one or more pressure sensors provide real-time data on the effectiveness of the first pressure pump 110 operation. This information may be used to ensure that the first pressure pump 110 is operating within its designed pressure range, preventing potential issues such as cavitation or excessive backpressure. The pressure data collected by the pressure sensors may also be used for feedback control, allowing the apparatus 102 to automatically adjust the speed or other parameters of the first pressure pump 110 and/or other pressure pumps to maintain a desired pressure level. This helps to optimize the efficiency of the first pressure pump 110 and the overall apparatus 102, reducing energy consumption and maintenance costs. Additionally, the one or more pressure sensors may provide early warning signs of potential problems, such as a gradual decrease in pressure due to wear or fouling of the pump's internal components. By monitoring these trends, preventive maintenance may be scheduled, minimizing unplanned downtime, and extending the pump's lifespan.

In operation, the controller 108 is configured to receive the pressure data associated with the first boosted liquid stream at the second port 116. The pressure data comprises a first pressure value. In an example, the controller 108 of the apparatus 102 may receive the pressure data from one or more pressure sensors placed or near the second port 116. The one or more pressure sensors may sense the pressure of the first boosted liquid stream at the second port 116. Further, the controller 108 may receive the first pressure value associated with the first boosted liquid stream at the second port 116.

Further, the controller 108 may be configured to compare the first pressure value with a second pressure value. In an example, the controller 108 may be configured to analyze the received first pressure data and assess it against the second pressure value. By continuously monitoring the first pressure value, the controller 108 may determine when the first pressure value is less than the second pressure value. For example, the second pressure value may be at, but not limited to, 7 bar. Further, the apparatus 102 may compare the first pressure value associated with the first boosted liquid stream at the second port 116 with the second pressure value associated with the brine stream 118.

The controller 108 may be further configured to control the first valve 120 or the second valve 122 to selectively feed the brine stream 118 to the first port 114 or the second port 116, respectively, based on the comparison. In an embodiment, the apparatus 102 is configured to control selectively feeding of the brine stream 118 either through the first valve 120 to the first port 114, or through the second valve 122 to the second port 116 to meet pressure requirement at the first port 114 and/or the second port 116. This control is based on a comparison of the first pressure value with the second pressure value, allowing the apparatus 102 to direct the brine stream 118 to either the first port 114 or the second port 116 as needed.

In an example, the first pressure pump 110 may elevate the pressure of the incoming liquid stream 104 to a level that is suitable for the subsequent components, such as another pressure pump or the treatment unit 112 of the apparatus 102. Specifically, the first pressure pump 110 increases the pressure of the liquid stream 104 from a first pressure level to a second pressure level to produce the first boosted liquid stream having a pressure to ensure that it meets the requirements for further processing. For instance, the first boosted liquid stream may then be directed to another pressure pump, which further increases its pressure before feeding to the treatment unit 112. This sequential pressure enhancement is essential to meet the required feed pressure to an RO process in the treatment unit 112. The treatment unit 112, in turn, may output the brine stream 118, which is a concentrated solution of salts and impurities, thus completing the cycle of liquid treatment and resource recovery within the apparatus 102.

In an embodiment, the controller 108 is configured to make decisions based on the comparison between the measured first pressure value and the second pressure value. The second pressure value may correspond to the pressure level of brine stream 118. If the first pressure value at the second port 116 is less than the second pressure value, the pressurized brine stream 118 may have to be mixed with the first boosted liquid stream at the second port 116. In an example, the second pressure value associated with the brine stream 118 is high, typically ranging from 6 to 9 bar, it becomes feasible to harness the energy of the brine stream 118 at the second port 116. The high-pressure brine stream 118 may be effectively utilized to enhance the overall efficiency of the apparatus 102. By integrating the energy of the brine stream into the process, the apparatus 102 may optimize performance, reduce energy consumption, and improve the treatment of the liquid stream 104. Subsequently, in such a condition, the controller 108 may control the second valve 122 to cause the flow of the brine stream 118 to the second port 118 thereby mixing the brine stream 118 with the first boosted liquid stream, i.e., the liquid stream 104 boosted by the first pressure pump 110.

On the contrary, if the first pressure value at the second port 116 greater than the second pressure value, the controller 108 may control the first valve 120 to cause the flow of the brine stream 118 to the first port 114 thereby mixing the brine stream 118 with the liquid stream 104. In this scenario, mixing the pressurized brine stream 118 with the first boosted liquid stream at the second port 116 would be inefficient, as it would waste the energy already imparted to the liquid stream 104 by the first pressure pump 110. Subsequently, in such a condition, the controller 108 may control the first valve 120 to cause the flow of the brine stream 118 to the first port 116 thereby mixing the brine stream 118 with the feed water, i.e., the liquid stream 104. When the brine stream 118 is mixed with the liquid stream 104, a pressure level of an input to the first pressure pump 110 may increase, requiring reduced or negligible power or energy by the first pressure pump 110 to boost the liquid stream 104 mixed with the brine stream 118 to produce the first boosted liquid stream. In certain cases, when the first pressure pump is operating in a range substantially less than a desired range, then the brine stream 118 mixed with the liquid stream 104 may enable the first pressure pump 110 to produce the first boosted liquid stream having a desired pressure range.

This integration of the pressurized brine stream 118 enhances the overall efficiency of the apparatus 102, as the energy is effectively harnessed for further processing.

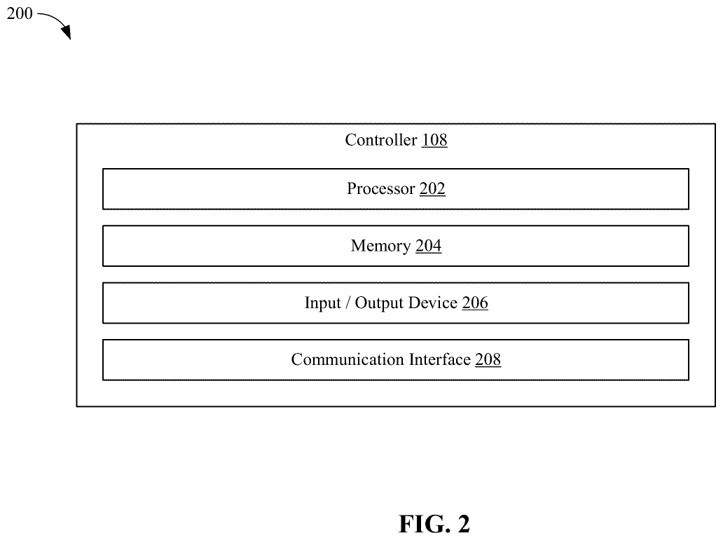

FIG. 2 illustrates a block diagram 200 of the controller 108 of the apparatus 102 for controlling selective feeding of the brine stream 118, in accordance with an embodiment of the disclosure. FIG. 2 is explained in conjunction with an element of FIG. 1. The controller 108 may include at least one processor 202 (referred to as a processor 202, hereinafter), at least one non-transitory memory 204 (referred to as a memory 204, hereinafter), an input/output (I/O) interface 206, and a communication interface 208. The processor 202 may be connected to the memory 204, the I/O interface 206, and the communication interface 208 through one or more wired or wireless connections. Although in FIG. 2, it is shown that the controller 108 includes the processor 202, the memory 204, the I/O interface 206, and the communication interface 208, however, the disclosure may not be so limiting and the controller 108 may include fewer or more components to perform the same or other functions of the controller 108.

The processor 202 of the controller 108 may be configured to perform seawater RO. The processor 202 may be embodied as one or more of various hardware processing means such as a co-processor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the controller 108.

For example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202.

The communication network 104 may be accessed using the communication interface 208 of the controller 108. The communication interface 208 may provide an interface for accessing various features and data stored in the controller 108.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the controller 108 to carry out various functions in accordance with an example embodiment of the present disclosure. For example, the memory 204 may be configured to buffer input data for processing by the processor 202. As exemplified in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an Application Specific Integrated Circuit (ASIC), Field Programmable Gate Array (FPGA), or the like, the processor 202 may be specifically configured hardware for conducting the operations described herein. In an embodiment, memory may be configured to store the first pressure value.

In some example embodiments, the I/O interface 206 may communicate with the controller 108 and display the input and/or output of the controller 108. As such, the I/O interface 206 may include a display and, in some embodiments, may also include a keyboard, a mouse, a touch screen, touch areas, soft keys, or other input/output mechanisms. In one embodiment, the controller 108 may include a user interface circuitry configured to control at least some functions of one or more I/O interface elements such as a display and, in some embodiments, a plurality of speakers, a ringer, one or more microphones and/or the like. The processor 202 and/or I/O interface 206 circuitry including the processor 202 may be configured to control one or more functions of one or more I/O interface 206 elements through computer program instructions (for example, software and/or firmware) stored on a memory 204 accessible to the processor 202.

The communication interface 208 may include the input interface and output interface for supporting communications to and from the controller 108 or any other component with which the controller 108 may communicate. The communication interface 208 may be any means such as a device or circuitry embodied in either hardware or a combination of hardware and software that is configured to receive and/or transmit data to/from a communications device in communication with the controller 108. In this regard, the communication interface 208 may include, for example, an antenna (or multiple antennae) and supporting hardware and/or software for enabling communications with a wireless communication network. Additionally, or alternatively, the communication interface 208 may include the circuitry for interacting with the antenna(s) to cause transmission of signals via the antenna(s) or to handle receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB), or other mechanisms.

Pursuant to embodiments of the present disclosure, the controller 108 may be connected to the first pressure pump 110 of the apparatus 102. The first pressure pump 110 comprises the first port 114 and the second port 116. The first pressure pump 110 may take input, i.e., the liquid stream 104, at the first port 114. Further, the first pressure pump 110 may output the first boosted liquid stream at the second port 116. The primary function of the first pressure pump 110 is to increase a pressure level of the incoming liquid stream 104. By elevating the pressure, the first pressure pump 110 ensures that the liquid stream 104 meets the operational requirements for subsequent processes within the apparatus 102. This pressure increase is essential for optimizing the performance of downstream components and enhancing the overall efficiency of the apparatus 102.

In an example, the controller 108 may be connected to the first valve 120 and/or the second valve 122 of the first pressure pump 110 to control the flow of the brine stream 118 therethrough.

In an example, the apparatus 102 may also include a second pressure pump (not shown in FIG. 2), which may be used downstream to the first pressure pump 110 for further boosting the pressure level of the first boosted liquid stream. For example, the controller 108 may be connected to the second pressure pump. The second pressure pump may receive the first boosted liquid stream as input from the second port 116 of the first pressure pump 110. Subsequently, the second pressure pump may be able to efficiently further boost the pressure of the first boosted liquid stream, taking advantage of the pressure already imparted by the first pressure pump 110. By taking in the first boosted liquid stream, the second pressure pump applies additional pressure to the liquid to produce a second boosted liquid stream as its output. This second boosting stage is crucial for ensuring that the liquid stream 104 reaches a desired pressure level before it is fed to the RO process of the treatment unit 112, thereby meeting specific pressure requirements for optimal performance of the treatment unit 112. The second pressure pump 304 may be configured to handle higher pressure levels, allowing it to elevate the liquid stream 104 to the desired higher-pressure range compared to the pressure range of the first pressure pump 110. By utilizing two pressure pumps in succession, the apparatus 102 may achieve a more precise and controlled pressure profile, optimizing the performance of the treatment or desalination process of the treatment unit 112.

The apparatus 102 may further include the treatment unit 112. The treatment unit plays a crucial role in the overall operation of the apparatus 102, as it is responsible for filtering the liquid stream 104. The treatment unit 112 is designed to enhance the quality of the liquid stream 104 through various treatment processes, ensuring that it meets the necessary standards for subsequent applications and is fit for human consumption. Typically, the treatment unit 112 employs advanced filtration and purification technologies to remove impurities, contaminants, and undesirable substances from the liquid stream 104. This may include processes such as sedimentation, coagulation, and disinfection, depending on the specific requirements of the application. The efficiency of the treatment unit 112 is enhanced by its integration with a pressure management system, allowing it to operate under optimal pressure conditions. By maintaining the appropriate pressure levels in the liquid stream fed to the treatment unit 112, the treatment unit 112 may achieve better flow rates and treatment efficiency.

To this end, the treatment unit 112 is connected, i.e., is in fluid communication, with the first pressure pump 110 or the second pressure pump. In an example, the first pressure pump 110 may be a low-pressure pump (LPP) that takes the liquid stream 104 as input and produces the first boosted liquid stream as output. The first pressure pump 110 is further connected, i.e., is in fluid communication, with the second pressure pump. In an example, the second pressure pump may be a high-pressure pump (HPP) that takes the first boosted liquid stream as input and produces the second boosted liquid stream as output. Thereafter, the treatment unit 112 is connected, i.e., is in fluid communication, with the second pressure pump. Subsequently, the treatment unit 112 is fed with the second boosted liquid stream to produce permeate stream and the brine stream 118.

In an example, the treatment unit 112 may include a first pass for a first level of water purification and a second-pass for a second level of water purification. To this end, the brine stream 118 may be produced at the first pass or the second pass. Pursuant to embodiment of the present disclosure, the brine stream 118 may be produced as the second pass of the treatment unit 112.

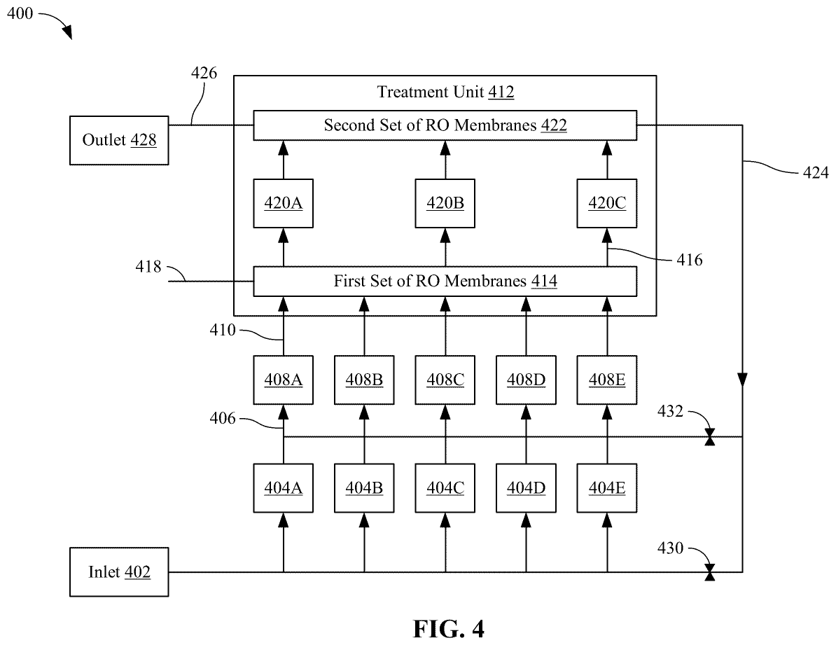

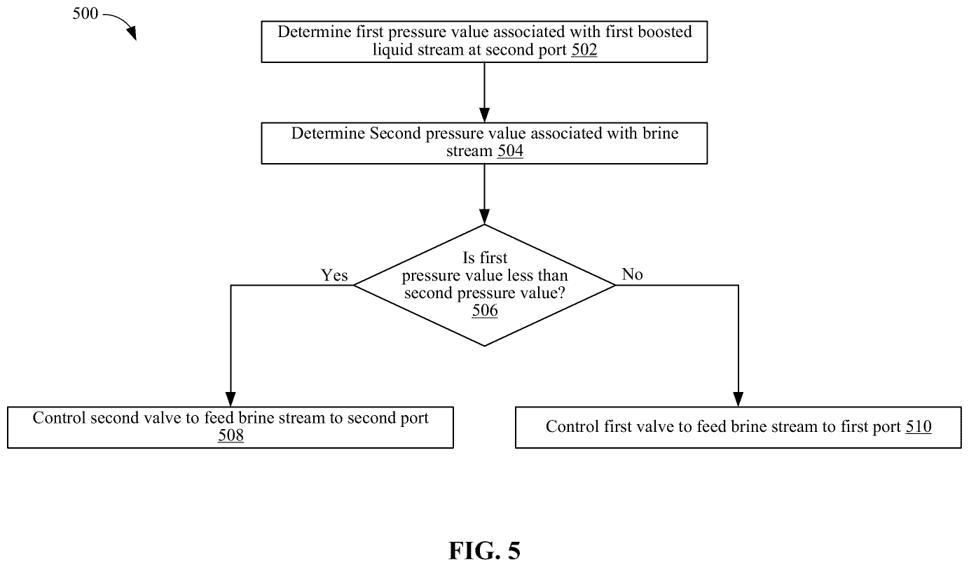

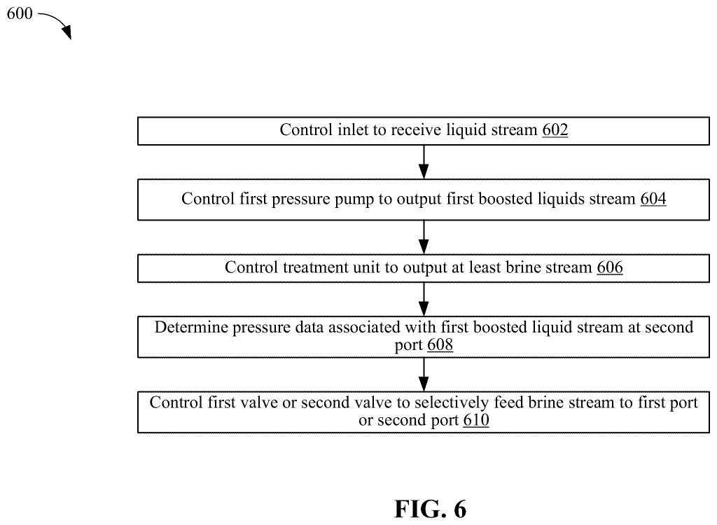

According to the present disclosure, the controller 108 is configured to control the supply of the brine stream 118 to either the first valve 114 or the second valve 116 for improving energy efficiency of the apparatus 102. A manner in which the controller 108 operates to selectively control the flow of the brine stream 118 is described in detail in conjunction with, for example, FIG. 1, FIG. 3A, FIG. 3B, FIG. 4, FIG. 5, and FIG. 6.

FIG. 3A illustrates a schematic flow diagram 300A of exemplary operations for brine recirculation mechanism, in accordance with an exemplary embodiment of the present disclosure. With reference to FIG. 3A, there is shown the flow diagram 300A that illustrates exemplary operations as described herein. Although illustrated with discrete blocks, the exemplary operations associated with one or more blocks of the flow diagram 300A may be divided into additional blocks, combined into fewer blocks, or eliminated, depending on the implementation. FIG. 3A is explained in conjunction with elements of FIG. 1 and FIG. 2.

In an embodiment, the liquid stream 104 may be fed to the inlet 106 for brine recirculation. The liquid stream 104 may be pre-treated seawater, or a mixture of the pre-treated seawater and the brine stream 118. The liquid stream 104 may be supplied at a first pressure level to the inlet 106. In an example, the first pressure level of the liquid stream 104 may lie in a range of, for example, but not limited to, 2 bar to 4 bar.

In an embodiment, the inlet 106 may receive the liquid stream 104 at a first pressure level. The inlet 106 may receive the liquid stream 104 at the first pressure level and supply the liquid stream 104 to the first pressure pump 110.

In an embodiment. the first pressure pump 110 may correspond to an LPP. The first pressure pump 110 may be configured to boost the first pressure level of the liquid stream 104 to a second pressure level to produce a first boosted liquid stream 302. To this end, the second pressure level is higher than the first pressure level. The first pressure pump 110 may supply the first boosted liquid stream 302 to a second pressure pump 304.

In an exemplary embodiment, the first pressure pump 110 may receive the liquid stream 104 from the inlet 106. The first pressure pump 110 may increase the pressure of the liquid stream 104 from the first pressure level to the second pressure level. In an example, the first pressure level may be up to 2 bar and the second pressure level may be in a range of 4 bar to 7 bar. The first pressure pump 110 may receive the liquid stream 104 through the first port 114 and output the first boosted liquid stream 302 through its second port 116. In an example, the first port 114 may be a suction header and the second port 116 may be a discharge header of the first pressure pump 110.

In an example, the first pressure pump 110 may receive the liquid stream through the suction header. For example, the first pressure pump 110 may increase the pressure of the liquid stream 104 from the first pressure level of, say 2 bar, to a second pressure level of, say 4 bar. The first pressure pump 110 may output the first boosted liquid stream 302 through the discharge header.

In an embodiment, the apparatus 102, or the controller 108 may be further configured to control the second pressure pump 304 to output a second boosted liquid stream 306 using the first boosted liquid stream 302. The second pressure pump 304 may be in fluid communication with the first pressure pump 110. For example, the second pressure pump 304 may receive the first boosted liquid stream 302 from the second port 116 of the first pressure pump 110. The second pressure pump 304 may further boost the pressure of the first boosted liquid stream 302 to output the second boosted liquid stream 306.

In an embodiment, the second pressure pump 304 may include a high-pressure pump (HPP). The second pressure pump 304 is configured to boost the second pressure level of the first boosted liquid stream 302 to a third pressure level of the second boosted liquid stream 306, such that the third pressure level is higher than the second pressure level.

In an exemplary embodiment, the second pressure pump 304 may increase the pressure of the first boosted liquid stream 302 from the second pressure level to the third pressure level. In an example, the third pressure level may be greater than, for example, 9 bar. Further, the second pressure pump 304 may supply the second boosted liquid stream 306 to the treatment unit 112 at the third pressure level.

In an example, the first boosted liquid stream 302 may be transferred to the second pressure pump 304 at the second pressure level of 4 bar. The second pressure pump 304 may increase the pressure of the first boosted liquid stream 302 from the second pressure level of 4 bar to the third pressure level of 11 bar. The second boosted liquid stream 306 may be transferred to the treatment unit 112 for seawater RO treatment process or desalination process.

In an embodiment, the treatment unit 112 may receive the second boosted liquid stream 306 at the third pressure level. Further, the treatment unit 112 may treat the second boosted liquid stream 306 to output the brine stream 118. The treatment unit 112 may use a set of reverse osmosis (RO) membranes to separate particles and solutes from the second boosted liquid stream 306 to produce the brine stream 118. The treatment unit 112 may operate on the principle of sieving, allowing water and small molecules to pass through while retaining larger particles.

In an embodiment, the controller 108 of the apparatus 102 may be configured to control the first valve 120 or the second valve 122 to selectively feed the brine stream 118 to the first port 114 or the second port 116, respectively, based on pressure data. In an example, the brine stream 118 may be second pass brine stream supplied from the treatment unit 112. The apparatus 102 may be configured to control the first valve 120 or the second valve 122 to selectively feed the second pass brine stream to either the first port 114 or the second port 116, respectively. The first valve 120 or the second valve 122 may be controlled based on the pressure data. The pressure data may be received from the one or more pressure sensors. The pressure sensors may be arranged at or near the first port 114, the second port 116, the second pressure pump 304 and/or the treatment unit 112 to take pressure readings of the liquid stream 104, the first boosted liquid stream 302, the second boosted liquid stream 306, or the brine stream 118.

In an exemplary embodiment, the apparatus 102 may receive the pressure data from the one or more pressure sensors. The pressure data may include a first pressure value associated with the first boosted liquid stream 302. The first pressure value may be compared with the second pressure value to determine whether the first pressure value is less than the second pressure value or not. Upon the determination that the first pressure value is less than the second pressure value, the controller 108 of the apparatus 102 may control the second valve 122 to direct the pressurized brine stream 118 directly to the second port 116. Here, the brine stream 118 is mixed with the first boosted liquid stream 302, allowing for the utilization of the brine stream's inherent pressure to increase the pressure of the first boosted liquid stream 302. For example, When the first pressure value falls below the second pressure value, it may suggest an opportunity to leverage the energy of the pressurized brine stream 118. In such scenarios, the brine stream 118 is mixed with the first boosted liquid stream 302 and the mixture is fed to the second pressure pump 304. In this regard, the first pressure pump 110 may utilize less power or energy as lesser flow of water is flowing through the first pressure pump 110, i.e., the first pressure pump 110 may have to increase pressure of a small volume of water requiring less flow, leading to reduced power consumption. By strategically utilizing the energy from the high-pressure brine stream 118, the apparatus 102 may optimize its operations, minimizing the workload on the first pressure pump 110 and, consequently, lowering the overall energy demands.

In another embodiment, if the first pressure value is greater than the second pressure value, then the controller 108 may adjust the first valve 122 to direct the brine stream 118 to the first port 114. In this case, when the first pressure value exceeds the second pressure value, it suggests that brine stream pressure value is not sufficient to mix with the first boosted liquid stream. In such cases, adding the brine stream 118, which may have a lower pressure value compared to the first pressure value, could potentially disrupt the apparatus's balance and lead to inefficiencies. By redirecting the brine stream 118 to the first port 114, the controller 108 ensures that the pressure levels within the apparatus 102 remain within the desired range.

In an example, the apparatus 102 may compare the first pressure value of, say 5 bar, of the first boosted liquid stream 302 to the second pressure value of, say 8 bar. Upon determining the first pressure value to be less than the second pressure value, the controller 108 may control the second valve 122 to direct the pressurized brine stream 118 to the second port 114.

FIG. 3B illustrates a block diagram 300B of the treatment unit 112 for brine recirculation mechanism, in accordance with an embodiment of the present disclosure. The exemplary operations illustrated in the block diagram 300B may be performed by the controller 102 of FIG. 1 or the processor 202 of FIG. 2. The exemplary operations associated with one or more blocks of the block diagram of FIG. 3B is explained in conjunction with elements of FIG. 1, FIG. 2, and FIG. 3A.

In an embodiment, as explained in conjunction with the FIG. 3A, the second boosted liquid stream 306 may be produced by the second pressure pump 304. The second boosted liquid stream 306 may be further supplied to the treatment unit 112. In an example, the second boosted liquid stream 306 may be derived from the first boosted liquid stream 302, which has been elevated to a higher-pressure level, referred to as the third pressure level. The second boosted liquid stream 306 may be supplied to the treatment unit 112 for desalination of the second boosted liquid stream 306 using a set of RO membranes.

In an embodiment, the treatment unit 112 may separate particles and solutes from the second boosted liquid stream 306. The treatment unit 112 may operate on the principle of sieving, allowing water and small molecules to pass through while retaining larger particles.

In an embodiment, the treatment unit 112 comprises a first set of reverse osmosis (RO) membranes 308 and a second set of RO membranes 314. In an example, the first set of RO membranes 308 is fed with the second boosted liquid stream 306 to output at least a first permeate stream 310 and a first pass brine stream 312. Further, the second set of RO membranes 314 is fed with the first permeate stream 310 to output at least a second permeate stream 316 and a second pass brine stream 318. In an example, the first set of RO membranes 308 may include a plurality of RO membranes for performing a first-pass water purification process. Similarly, the second set of RO membranes 310 may also include a plurality of RO membranes for performing a second pass water purification process. In an example, the plurality of RO membranes of the first set of RO membranes 308 may be different from the plurality of RO membranes of the second set of RO membranes 310 in terms of porosity, size, thickness, etc.

In an embodiment, the first set of RO membranes 308 may receive the second boosted liquid stream 306 from the second pressure pump 304 at the third pressure level. The first set of RO membranes 308 may filter the received second boosted liquid stream 306 to output the first permeate stream 310 and the first pass brine stream 312. The first pass brine stream 312 may be the concentrated solution of salts and other dissolved solids. Further, the first permeate stream may be purified or partially purified water.

Further, the first permeate stream 310 may be passed through the second set of RO membranes 314. The second set of RO membranes 308 may further filter or purify the received first permeate stream 310 to output the second permeate stream 316 and the second pass brine stream 318. The second pass brine stream 318 may be the concentrated solution of salts and other dissolved solids. Further, the operations of the second set of RO membranes 314 may be similar to the first set of RO membranes 308 for performing the seawater desalination or RO process. The flow of the second pass brine stream 318 may be further controlled by the controller 108 to be supplied to either the second port 116 through the second valve 122 or to the first port 114 through the first valve 120. Details of the operation of the controller are described in conjunction with, for example, FIG. 1, FIG. 3A, FIG. 4, FIG. 5, and FIG. 6.

FIG. 4 illustrates a block diagram 400 of exemplary operation of the apparatus 102 for selectively feeding the brine stream 118, in accordance with an embodiment of the disclosure. FIG. 4 is explained in conjunction with FIG. 1, FIG. 2, FIG. 3A and FIG. 3B. The exemplary operations illustrated in the block diagram 400 may be performed by any computing system, or device, such as by the apparatus 102 of FIG. 1 or the controller 108 of FIG. 1. Although illustrated with discrete blocks, the exemplary operations associated with one or more blocks of the block diagram 400 may be divided into additional blocks, combined into fewer blocks, or eliminated, depending on the particular implementation.

In an embodiment, the inlet 402 is responsible for receiving the liquid stream 104. The liquid stream may include, but is not limited to, seawater. The inlet 402 is an example of the inlet 106, described in FIG. 1. The liquid stream 104 may be sourced either from a storage tank or directly from the ocean. In an example, the inlet 402 may be equipped with one or more nets to enhance the quality of the incoming liquid stream 104. The one or more nets may be designed to capture solid impurities that could potentially affect the components of the apparatus 102, such as the pressure pumps 110 or 304 and/or the RO membranes of the treatment unit 112. Once the liquid stream 104 is filtered through the inlet 402, it is directed to a plurality of first pressure pumps (depicted as a first pressure pump 404A, a first pressure pump 404B, a first pressure pump 404C, a first pressure pump 404D and a first pressure pump 404E, and collectively referred to as first pressure pumps 404.). In an embodiment, the plurality of first pressure pumps 404 may comprise either an increased number of first pressure pumps or a reduced number of first pressure pumps, as illustrated in FIG. 4, and this should not be considered a limitation.

In an embodiment, each of the first pressure pumps 404 is an example of the first pressure pump 110 as described in FIG. 1. Each first pressure pump of the first pressure pumps 404 comprises a first port and a second port. The first port receives the liquid stream 104, or a part thereof from the inlet 402. Following this, each of the first pressure pumps 404 outputs a first boosted liquid stream 406. The first boosted liquid stream 406 is output at the second port of each of the first pressure pumps 404. For instance, a first pressure pump, say, the first pressure pump 404A is configured to boost the first pressure level of the liquid stream 104 or a part of the liquid stream 104 to the second pressure level to produce the first boosted liquid stream 406. In an example, the liquid stream 104 received at the inlet 402 is at, say 2-bar pressure. The first pressure pump 404A may output the first boosted liquid stream 406 having the second pressure level such as, for example, 6 bar.

Further, the apparatus 102 comprises a plurality of second pressure pumps (depicted as a second pressure pump 408A, a second pressure pump 408B, a second pressure pump 408C, a second pressure pump 408D and a second pressure pump 408E, and collectively referred to as second pressure pumps 408). Each of the second pressure pumps 408 is an example of the second pressure pump 304 as described in FIG. 3A. It may be noted that a count of the first pressure pumps 404 and the second pressure pumps 408 to be five is only exemplary and should not be construed as a limitation. In an embodiment, the plurality of second pressure pumps 408 may comprise either an increased number of second pressure pumps or a reduced number of second pressure pumps and this should not be considered a limitation. Moreover, the plurality of first pressure pumps 404 may comprise either an increased number of first pressure pumps or a reduced number of first pressure pumps and this should not be considered a limitation.

The first pressure pumps 404 may comprise low-pressure pumps, while the second pressure pumps 408 comprises high-pressure pumps. This configuration allows the apparatus 102 to efficiently manage pressure boosting of the liquid stream 104 at different pressure levels. The first pressure pumps 404 may boost the incoming liquid stream 104 to a moderate pressure level, preparing it for further processing. Moreover, the second pressure pumps 408 further elevates the pressure level of the first boosted liquid stream 406 for specialized applications such as, the RO process.

In an embodiment, a second pressure pump, say the second pressure pump 408A is configured to boost the second pressure level of the first boosted liquid stream 406 to a third pressure value of a second boosted liquid stream. In an example, each of the second pressure pumps 408 outputs a second boosted liquid stream 410. The second pressure pump 408A may output the second boosted liquid stream 410 at the third pressure level such as, but not limited to, 12 bar.

Further, the second boosted liquid stream 410 is fed into a treatment unit 412. The treatment unit 412 is an example of the treatment unit 112 as described in FIG. 1. The treatment unit 412 includes a first set of RO membranes 414 for performing the first pass of desalination or water purification. In this regard, each of the first set of RO membranes 414 may yield a first permeate stream 416 and a first pass brine stream 418. Moreover, the treatment unit 412 includes a second set of RO membranes 422 for performing the second pass of desalination or water purification. In this regard, each of the second set of RO membranes 422 may yield a second permeate stream 426 and a second pass brine stream 424.

Further, the treatment unit 412 includes a plurality of third pressure pumps (depicted as a third pressure pump 420A, a third pressure pump 420B and a third pressure pump 420C, and collectively referred to as third pressure pumps 420). The third pressure pumps 420 may be operable to further pressurize the first permeate stream 416. The pressurized first permeate stream 416 may then be passed through the second set of RO membranes 422.

In an embodiment, the second permeate stream 426 may be fed to the outlet 428. The second permeate stream 426 may be stored in a freshwater tank. The second permeate stream 426 may be used for, for example, but not limited to, human consumption, water supply, industrial applications, or irrigation. The pressure level of the second pass brine stream 424 is high.

Further, the controller 108 of the apparatus 102 is configured to determine a first pressure value associated with the first boosted liquid stream at the second port 406 of each of the first pressure pumps 404. In addition, the controller 108 of the apparatus 102 may be configured to determine a second pressure value associated with the second pass brine stream 424. In an example, the first pressure value and the second pressure value may be determined using pressure sensors. Moreover, the second pass brine stream 424 may be summation of second pass brine stream produced by each of the second set of RO membranes 422/

Further, the controller 108 is configured to compare the first pressure value of the first boosted liquid stream with the second pressure value. Based on the comparison, the controller 108 may be configured to control a second valve 432 to direct the flow of the second pass brine stream 424 into the second port 406. In this regard, the second pass brine stream 424 is mixed with the first boosted liquid stream and the mixture is then transferred to the second pressure pumps 408. The second valve 432 is an example of the second valve 122 as described in FIG. 1.

In another embodiment, based on the comparison, if the controller 108 determines the first pressure value of the first boosted liquid stream to be greater than the second pressure value, then the controller 108 is configured to control a first valve 430 to feed the second pass brine stream 424 to the first port of the first pressure pumps 404. Further the second pass brine stream 424 is mixed with the liquid stream 104 received from the inlet 402. The mixture of the second pass brine stream 424 and the liquid stream 104 is directed to the first port of the first pressure pumps 404. The first valve 430 is an example of the first valve 120 as described in the FIG. 1.

FIG. 5 is a flowchart 500 of an exemplary method for controlling a flow of the second pass brine stream 318, in accordance with an embodiment of the disclosure. FIG. 5 is explained in conjunction with elements from FIG. 1, FIG. 2, FIG. 3A, FIG. 3B, and FIG. 4. The operations of the exemplary method may be executed by any computing system, for example, by the apparatus 102 of FIG. 1 or the controller 202 of FIG. 2. The operations of the flowchart 500 may start at 502.

At 502, a first pressure value associated with the first boosted liquid stream 302 at second port 116 is determined. In an embodiment, the controller 108 of the apparatus 102 may configured to determine, using one or more pressure sensors, the first pressure value associated with the first boosted liquid stream 302 at the second port 116. In an example, the first pressure value may correspond to a pressure level of the first boosted liquid stream 302 at the second port 116. For instance, the first pressure value of the first boosted liquid stream 302 is excepted to within a pressure range of 5.0 bar to 10 bar, but the operational pressure of the first boosted liquid stream 302 at the second port 116 is between the pressure of 4.0 bar to 7.0 bar.

At 504, a second pressure value associated with brine stream 118 is determined. The second pressure value may correspond to a pressure level of the brine stream 118. In an example, the brine stream 118 is a second pass brine stream ejected from the treatment unit 112. In an example, the second pressure value may be 8.0 bar.

At 506, the first pressure value is compared with the second pressure value. In an embodiment, the controller 108 may be configured to compare the first pressure value with a second pressure value associated with the brine stream 118 to ascertain whether the first pressure value is less than the second pressure value or not. For instance, the comparison process involves continuously monitoring the first pressure value and checking if it is less than 8.0 bar of pressure.

In an example, the controller 108 of the apparatus 102 is configured to determine whether the first pressure value is less than the second pressure value. Specifically, the controller 102 evaluates whether the measured first pressure value is lesser than the second pressure value.

In one embodiment, if the controller 108 determines that the first pressure value is less than the second pressure value, the operation may move to 508. In another embodiment if the controller 108 determines that the first pressure value is greater than the second pressure value, the operation may move to 510.

At 508, the second valve 122 is controlled to feed the second pass brine stream 318 to the second port 116. In one embodiment, the controller 102 is configured to control the second valve 122 to feed the second pass brine stream 318 to the second port 116 in response to determining that the first pressure value is less than the second pressure value. In an example, if the controller 108 identifies the pressure of the first boosted liquid stream 302 as 6 bar, and the second pressure value is established as 7.0 bar, the controller 108 may operate or control the second valve 122 to feed the second pass brine stream 318 to the second port 116. In this manner, the controller 108 may continuously monitor the first pressure value of the first boosted liquid stream 302 in each batch. In an example, the second pressure value associated with the second pass brine stream 318 is also significant, typically ranging between 6.0 bar and 9.0 bar. This pressure aligns well with that of the first boosted liquid stream 302, making it advantageous to mix the two streams to reach desired pressure level for feed of the second pressure pump 304.

At 510, the first valve 114 is controlled to feed the second pass brine stream 318 to the first port 114. In an embodiment, the controller 108 of the apparatus 102 is configured to control the first valve 120 to feed the second pass brine stream 318 to the first port 114 in response to determining the first pressure value to be greater than the second pressure value. For example, the controller 108 determines the first pressure value of the first boosted liquid stream 302 at the second port 116 is 8 bar. Further the controller 108 may compare the first pressure value i.e., 8 bar, with the second pressure value i.e., 7.0 bar. On determining the first pressure level is being greater than the second pressure value, the controller 108 may control the first valve 120 to direct the flow of the second pass brine stream 318 to the first port 114 of the first pressure pump 110. For instance, the brine stream 118 is mixed with the liquid stream 104 received from the inlet 106 and then directed to the first pressure pump 110.

FIG. 6 is a flowchart 600 of an exemplary method for selectively feeding brine stream, in accordance with an embodiment of the disclosure. FIG. 6 is explained in conjunction with elements from FIG. 1, FIG. 2, FIG. 3A, FIG. 3B, FIG. 4, and FIG. 5. The operations of the exemplary method may be executed by any computing system, for example, by the controller 108 of FIG. 1 or the processor 202 of FIG. 2. The operations of the flowchart 600 may start at 602.

At 602, the inlet 106 is controlled to receive the liquid stream 104. The controller 108 may be configured to control the inlet to receive the liquid stream 104. In an example, the liquid stream 104 is pre-treated seawater, or a mixture of the of pre-treated seawater and the brine stream 118.

At 604, the first pressure pump 110 is controlled to output the first boosted liquid stream 302 using the received liquid stream 104. In an embodiment, the controller 108 may be configured to control the first pressure pump 110 to produce the first boosted liquid stream 302. The first pressure pump 110 comprises the first port 114 and the second port 116. The first port 114 receives the liquid stream 104, and the second port 116 outputs the first boosted liquid stream 302. The first pressure pump 110 may boost a first pressure level of the liquid stream 104 to a second pressure level.

At 606, the treatment unit 112 is controlled to output at least the brine stream 118 by passing the liquid stream 104 therethrough. In an example, the controller 108 may be configured to control the first boosted liquid stream 302 or the second boosted liquid stream 306 to pass through the treatment unit 112. The treatment unit 112 may include RO membranes. Subsequently, the treatment unit 112 may output permeate stream and brine stream 118. In an example, the brine stream 118 may be the second pass brine stream 318.

At 608, pressure data associated with the first boosted liquid stream 302 is determined at the second port 116. In an example, the controller 108 may be configured to determine the pressure data associated with the first boosted liquid stream 302 using one or more pressure sensors. For example, the pressure sensors may be arranged at or near the second port 116 of the first pressure pump 110.

At 610, one of the first valve 120 or the second valve 122 is controlled to selectively feed the brine stream 118 to one of: the first port 114 or second port 116, respectively. In an embodiment, the controller 108 may be configured to control the first valve 120 or the second valve 122 to selectively feed the brine stream 118 or the second pass brine stream 318 to the first port 114 or the second port 116, respectively, based on the pressure data. In an embodiment, the controller 108 may be configured to compare a first pressure value of the first boosted liquid stream 302 with a second pressure value. Further, the controller 108 may be configured to control the second valve 122 to feed the brine stream 118 to the second port 116 in response to determining the first pressure value to be less than the second pressure value. Alternatively, the controller 108 may be configured to control the first valve 120 to feed the brine stream 118 to the first port 114 in response to determining the first pressure value to be greater than of the second pressure value.

Accordingly, blocks of the flowcharts 500 and 600 support combinations of means for performing the specified functions and combinations of operations for performing the specified functions. It will also be understood that one or more blocks of the flowcharts 500 and 600 combinations of blocks in the flowcharts 500 and 600 can be implemented by special purpose hardware-based computer system which perform the specified functions, or combinations of special purpose hardware and computer instructions.

Alternatively, the apparatus 102 may comprise means for performing each of the operations described above. In this regard, according to an example embodiment, examples of means for performing operations may comprise, for example, the controller 108 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of reactants and/or functions, it should be appreciated that different combinations of reactants and/or functions may be provided by alternative embodiments without departing from the scope of the appended claims. In this regard, for example, different combinations of reactants and/or functions than those explicitly described above are also contemplated as may be set forth in some of the appended claims. Although specific terms are employed herein, they are used in a generic and descriptive sense only and not for purposes of limitation.

What is claimed is:

1. A method, comprising:
controlling an inlet to receive a liquid stream;
controlling a first pressure pump to output a first boosted liquid stream using the received liquid stream, the first pressure pump comprising a first port and a second port, wherein the first port receives the liquid stream, and wherein the second port outputs the first boosted stream;
controlling a treatment unit to output at least a brine stream by passing the liquid stream therethrough;
determining pressure data associated with the first boosted liquid stream at the second port; and
controlling one of: a first valve or a second valve to selectively feed the brine stream to one of: the first port or the second port, respectively, based on the pressure data.

2. The method of claim 1, wherein the pressure data comprises a first pressure value associated with the first boosted liquid stream at the second port, and wherein the method further comprises:
determining, using the one or more pressure sensors, a second pressure value associated with the brine stream;
comparing the first pressure value with the second pressure value; and
in response to determining the first pressure value to be less than the second pressure value, controlling the second valve to feed the brine stream to the second port.

3. The method of claim 2, wherein the method further comprises:
in response to determining the first pressure value to be greater than the second pressure value, controlling the first valve to feed the brine stream to the first port.

4. The method of claim 1, wherein the first pressure pump comprises a low-pressure pump (LPP), and wherein the first pressure pump is configured to boost a first pressure level of the liquid stream to a second pressure level of the first boosted liquid stream, such that the second pressure level is higher than the first pressure level.

5. The method of claim 1, wherein the method further comprises:
controlling a second pressure pump to output a second boosted liquid stream using the first boosted liquid stream, wherein the second pressure pump is in fluid communication with the first pressure pump.

6. The method of claim 5, wherein the second pressure pump comprises a high-pressure pump (HPP), and wherein the second pressure pump is configured to boost a second pressure level of the first boosted liquid stream to a third pressure level of the second boosted liquid stream, such that the third pressure level is higher than the second pressure level.

7. The method of claim 5, wherein
the treatment unit comprises a first set of reverse osmosis (RO) membranes and a second set of RO membranes,
the first set of RO membranes is fed with the second boosted liquid stream to output at least a first permeate stream and a first pass brine stream, and
the second set of RO membranes is fed with the first permeate stream to output at least a second permeate stream and a second pass brine stream.

8. The method of claim 7, wherein one of: the first valve or the second valve is controlled to selectively feed the second pass brine stream to one of: the first port or the second port, respectively, based on the pressure data.

9. The method of claim 1, wherein the liquid stream is one of: pre-treated seawater, or a mixture of the of pre-treated seawater and the brine stream.

10. A controller, comprising:
one or more processors configured to:
control an inlet to receive a liquid stream;
control a first pressure pump to output a first boosted liquid stream using the received liquid stream, the first pressure pump comprising a first port and a second port, wherein the first port receives the liquid stream, and wherein the second port outputs the first boosted stream;
control a treatment unit to output at least a brine stream by passing the liquid stream therethrough;
determine pressure data associated with the first boosted liquid stream at the second port; and
control one of: a first valve or a second valve to selectively feed the brine stream to one of:
the first port or the second port, respectively, based on the pressure data.

11. The controller of claim 10, wherein the pressure data comprises a first pressure value associated with the first boosted liquid stream at the second port; and wherein the one or more processors are further configured to:
determine using the one or more pressure sensors, a second pressure value associated with the brine stream;
compare the first pressure value with the second pressure value; and
in response to determining the first pressure value to be less than the second pressure value, control the second valve to feed the brine stream to the second port.

12. The controller of claim 11, wherein the one or more processors are further configured to:
control the first valve to feed the brine stream to the first port if it determines that the first pressure value is greater than the second pressure value.

13. The controller of claim 11, wherein the first pressure pump comprises a low-pressure pump (LPP), and wherein the first pressure pump is configured to boost a first pressure level of the liquid stream to a second pressure level of the first boosted liquid stream, such that the second pressure level is higher than the first pressure level.

14. The controller of claim 11, wherein the one or more processors are further configured to:
control a second pressure pump to output a second boosted liquid stream using the first boosted liquid stream, wherein the second pressure pump is in fluid communication with the first pressure pump.

15. The controller of claim 14, wherein the second pressure pump comprises a high-pressure pump (HPP), and wherein the second pressure pump is configured to boost a second pressure level of the first boosted liquid stream to a third pressure level of the second boosted liquid stream, such that the third pressure level is higher than the second pressure level.

16. The controller of claim 14, wherein
the treatment unit comprises a first set of reverse osmosis (RO) membranes and a second set of RO membranes,
the first set of RO membranes is fed with the second boosted liquid stream to output at least a first permeate stream and a first pass brine stream, and
the second set of RO membranes is fed with the first permeate stream to output at least a second permeate stream and a second pass brine stream.

17. The controller of claim 16, wherein one of: the first valve or the second valve is controlled to selectively feed the second pass brine stream to one of: the first port or the second port, respectively, based on the pressure data.

18. An apparatus, comprising:
an inlet to receive a liquid stream;
a first pressure pump to output a first boosted liquid stream using the received liquid stream, the first pressure pump comprising a first port and a second port, wherein the first port receives the liquid stream, and wherein the second port outputs the first boosted stream;
a treatment unit to output at least a brine stream by passing the liquid stream therethrough;
a first valve connected to the first port to control a water flow thereto;
a second valve connected to the second port to control a water flow thereto;
one or more pressure sensors arranged to measure pressure data associated with the first boosted liquid stream at the second port; and
a controller configured to
receive the pressure data associated with the first boosted liquid stream at the second port, wherein the pressure data comprises a first pressure value;
determine using the one or more pressure sensors, a second pressure value associated with the brine stream;
compare the first pressure value with the second pressure value; and
control one of: the first valve or the second valve to selectively feed the brine stream to one of: the first port or the second port, respectively, based on the comparison.

19. The apparatus of claim 18, wherein the first pressure pump comprises a low-pressure pump (LPP), and wherein the first pressure pump is configured to boost a first pressure level of the liquid stream to a second pressure level of the first boosted liquid stream, such that the second pressure level is higher than the first pressure level.

20. The apparatus of claim 18, further comprising:
a second pressure pump to output a second boosted liquid stream using the first boosted liquid stream, wherein the second pressure pump is in fluid communication with the first pressure pump.
